(19) United States
(12) Patent Application Publication
(10) Pub. No.: US 2017/0241144 A1
(43) Pub. Date: Aug. 24, 2017

(54) WOODEN FACADE ELEMENT

(71) Applicant: SCHLYTER GEZELIUS ARKITEKTKONTOR AB, Stockholm (SE)

(72) Inventor: Camilla Schlyter Gezelius, Stockholm (SE)

(21) Appl. No.: 15/506,732

(22) PCT Filed: Jul. 7, 2015
(86) PCT No.: PCT/EP2015/065425

§ 371 Date: Feb. 25, 2017

(30) Foreign Application Priority Data
Sep. 5, 2014 (SE) 1451040-8
Oct. 13, 2014 (SE) 1451222-2

(51) Int. Cl. E04F 13/10; E04C 2/12; B27F 1/02; B32B 21/14; B32B 3/30; B32B 3/18; B32B 7/00; B32B 21/13; E04F 13/08; B32B 21/04

(52) U.S. Cl. CPC E04F 13/10; E04F 13/0866; E04F 13/0871; E04F 13/0892; E04C 2/12; B27F 1/02; B32B 21/042; B32B 3/30; B32B 3/18; B32B 7/005; B32B 21/13; B32B 21/14; E04F 2203/00; B32B 2307/554; B32B 2307/304; B32B 2307/7265; B32B 2307/102; B32B 2307/7145; B32B 2419/00

(57) ABSTRACT

It is provided a cross-laminated wood façade element (1) that has an upper end (12) and a lower end (13), an inner surface (3), an outer surface (2) and a longitudinal axis (28) in the direction from the upper end (12) to the lower end (13), said element (1) comprising an inner layer (4) of timber elements (7) and at least one intermediate layer (5) of timber elements (7) where the grain of the timber elements (7) of the inner layer (4) and grain of the timber elements (7) of the at least one intermediate layer (5) are at least partially oriented in different directions, the façade element (1) further comprising an outer layer (6) comprising timber elements (7) in which the grain direction is oriented approximately parallel to the longitudinal axis (28), characterized in that the outer surface (2) of the façade element (1) has grooves (11) that are approximately parallel to the longitudinal axis (28).

### FIELD OF THE INVENTION

This invention relates to a façade element made of cross-laminated wood.

### BACKGROUND

Prefabricated façade elements are widely used in the building industry since it speeds up the building process. A façade element may be a panel, often with a rectangular shape, one or several of which can be attached to the framework of the building, thereby forming the façade or a significant part thereof.

It is desirable that the outer surface of the façade element can withstand wear and tear, does not crack, provides thermal insulation, and keeps moisture out, ages nicely and does not mildew. In addition, it is desirable that the façade element has suitable acoustic properties.

It is also desirable that the façade element of a certain building can obtain a unique design such that it enables the architect to express himself or herself.

Wood tends to warp, i.e. change its shape by for example bending or twisting in response to changes in moisture and temperature. This leads to deformation of the wood and also to the formation of cracks, which is undesirable since cracks do not look nice and may trap water which may cause mildew.

It is previously known that the cutting of grooves in the underside of floorboards—which is not visible—prevents the formation of cracks in the floorboard.

U.S. Pat. No. 6,009,679 discloses a façade element in a traditional style with overlapping planks that form horizontal grooves on the façade. This type of façade element has limited possibilities for varying the design of the outer layer because of the visible overlap.

### SUMMARY OF THE INVENTION

It is an object of the invention to solve at least some of the problems discussed above.

Therefore, in a first aspect of the invention there is provided a cross-laminated wood façade element that has an upper end and a lower end, an inner surface, an outer surface and a longitudinal axis in the direction from the upper end to the lower end, said façade element comprising an inner layer of timber elements and at least one intermediate layer of timber elements where the grain of the timber elements of the inner layer and the grain of the timber elements of the at least one intermediate layer are at least partially oriented in different directions, the façade element further comprising an outer layer comprising timber elements in which the grain direction is oriented approximately parallel to the longitudinal axis, where the outer surface of the façade element has grooves that are approximately parallel to the longitudinal axis.

The invention provides a façade element with a uniform surface, that is strong, that does not trap water, that obscures wear and tear, cracks less, and ages in a beautiful way, and that can be produced in a cost-efficient manner.

The profile of the grooves is preferably U-shaped. U-shaped grooves has advantages over for example, V-shaped grooves. U-shaped grooves tend to spread the water across a larger area which prevents water from seeping into the wood compared to V-shaped grooves. V-shaped grooves, on the other hand, tend to direct the water into the wood. Therefore U-shaped grooves are preferred. U-shaped grooves are also preferred over V-shaped grooves since V-shaped grooves tend to cause cracks along the grooves when the wood dries, in particular when the grooves are parallel to the fibers.

The grooves can be efficiently obtained milling the outer surface of the façade element.

The outer layer preferably comprises quartersawn timber elements. This provides a particularly uniform, durable and resistant outer surface.

The timber elements of the outer layer of the façade element can be connected with the use of rabbets. This has the advantage of minimizing water seepage into and trough the façade element.

The façade element may have rabbets or bevels for joining one façade element to another façade element on the façade. This has the advantage of minimizing water seepage between façade elements that are mounted.

The façade element may have rabbets or bevels such that, when two façade elements are mounted one above the other on a façade, a part of the lower end (in particular a part of the outer surface) of the upper element is arranged outside of a part of the upper end of the lower element. This prevents water seepage. Such rabbet or bevels may also define which end is the upper end and which end is the lower end of the façade element.

The façade element may have at least one mounting means for mounting the façade element on the framework of a building. This has the advantage of speeding up the building process.

In a preferred embodiment the outer surface of the façade element is covered by straight, parallel, vertical (thus parallel to the longitudinal axis) grooves with a U-shaped profile.

It is an advantage if as much a possible of the outer surface as possible is covered by grooves. It is preferred if the entire outer surface is covered by grooves. This releases tensions in an efficient manner and also leads away water in an efficient manner.

Straight and vertical grooves are advantageous since they trap water as little as possible.
The façade element may be such that, when the façade element is mounted on a framework, the distance from the framework to the lower edge of the outer surface of the façade element is the same as the distance from the framework to the upper edge of the outer surface. Thus the grooves may have the same depth and width at the upper edge and the lower edge. Thus the façade elements may have a thickness at the upper edge that varies along the upper edge of the outer surface, and a thickness that varies along the lower edge of outer surface, but the thickness at various points at the upper edge and the lower edge of the outer surface is the same. This enable building of façades with almost invisible joints.

In a second aspect of the invention it is provided a façade for a building, comprising a plurality of façade elements according to the invention, arranged in a row or matrix pattern next to one another.

In a third aspect of the invention there is provided a method for making a cross-laminated wood façade element comprising the steps of: a) preparing a piece of cross-laminated wood with the general shape of a rectangular parallelepiped that comprises an inner layer of timber elements and at least one intermediate layer of timber elements where the grain of the timber elements of the inner layer and the timber elements of the at least one intermediate layer are at least partially oriented in different directions, the piece of cross laminated wood further comprising an outer layer of timber elements where the grain direction of the outer layer is oriented approximately parallel to the outer surface of the outer layer and approximately parallel to a side of the rectangular parallelepiped, and b) shaping the piece of cross laminated wood by milling.

The milling step may be carried out on the outer layer to obtain grooves 11 that are approximately parallel to the grain direction of the outer layer.

The milling step may also be carried out to create at least one rabbet for joining one façade element 1 to another façade element 1.

Milling may preferably be carried out with a computer numerical control (CNC) milling machine.

### DRAWINGS

FIG. 1 shows a perspective of a façade element, with an example of U-shaped grooves on the outer surface of the element.

FIG. 2 shows a cross section of a façade element seen from the upper end or the lower end.

FIG. 3 shows a piece of cross laminated wood that forms a part of a façade element.

FIG. 4a-4e shows how a plurality of façade elements can be joined to form a façade of a building.

FIG. 5a shows how quartersawn timber is sawn from a log.

FIG. 5b shows a cross section of a timber element.

FIG. 6 shows different types of timber.

FIG. 7-9 are drawings of a façade element.

FIG. 10-11 are details of FIG. 9, showing the upper end and the lower end of a façade element.

FIGS. 12-15a and 15b illustrates different types of grooves on the surface of a façade element.

FIG. 16-19 shows how milling is used to obtain grooves on the surface of a façade element.

### DETAILED DESCRIPTION

The invention provides a façade, a façade element and a method for producing such an element. The façade element 1 is durable, is not prone to cracking or cracks in a controlled manner, is low-cost, ages in a beautiful manner, withstands wear and tear and provides a surface that is as uniform as possible which gives architects and designers great freedom in providing novel façade designs. In addition, the façade element 1 suppresses noise by absorbing, blocking or diffracting sound. By “uniform”, in this context, is meant a surface which may be essentially flat or display regular or irregular patterns, which patterns appear in a uniform manner across at least major part of the surface.

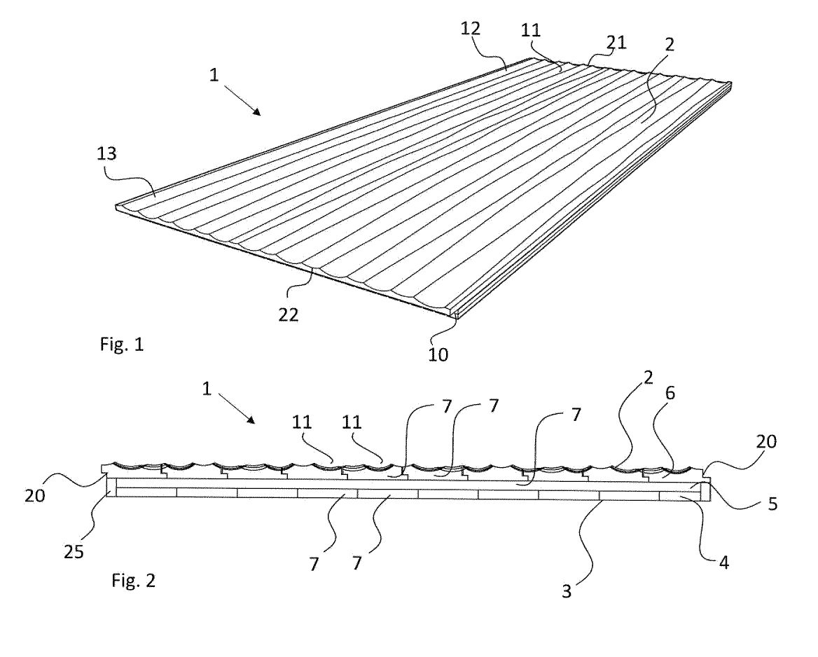

FIG. 1 shows a façade element 1 according to the invention. The façade element 1 may be thought of as a panel used for building.

The façade element 1 is intended to be fastened on the framework 14 of a building in the mounted position discussed below, thereby forming a significant part of the façade.

Alternatively, the façade element 1 can be used for building a façade without the use of a framework.

The façade element 1 can also be used for building noise barriers, such as highway noise barriers, roofs, interior walls and screens.

The element 1 is suitably produced in standardized sizes, such that there is provided a plurality (at least two) of identical or almost identical building elements.

The façade element 1 can be produced in a factory and transported to the building site where they can be rapidly fastened to the framework 14 of a building, thus forming the façade of the building. This speeds up the building process compared to building the façade plank by plank on the building site.

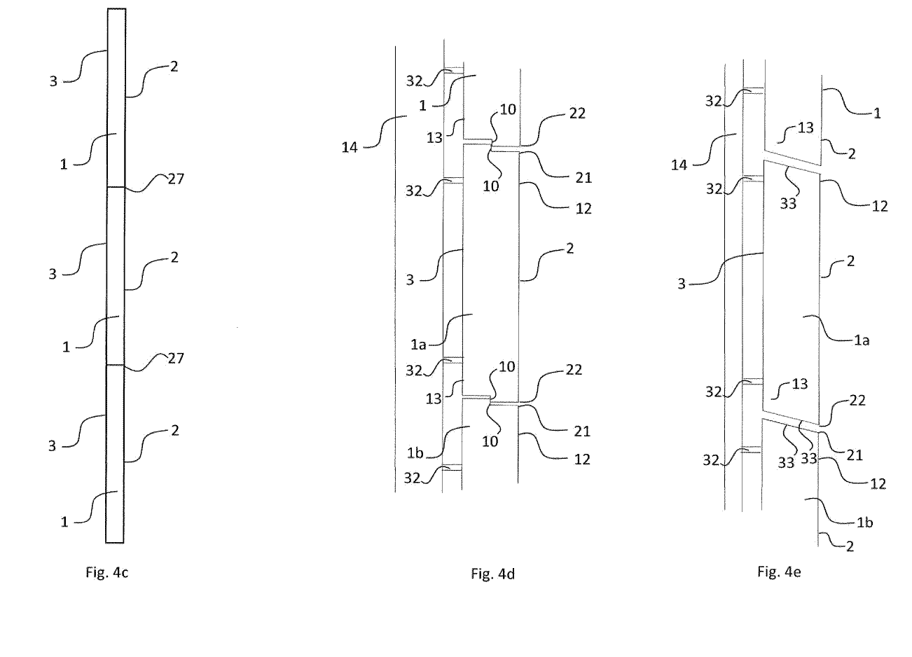

The façade element 1 may be an essentially rectangular panel, optionally with rabbets 10 and 20, the panel having a certain thickness. In particular, the outer surface 2 of the façade element 1 may have an essentially rectangular shape when the element 1 is mounted on a façade and seen from outside the building. FIGS. 4a and 4b shows how four façade elements 1 are connected to form a part of a façade, where the outer surface 2 of the façade elements 1 is rectangular.

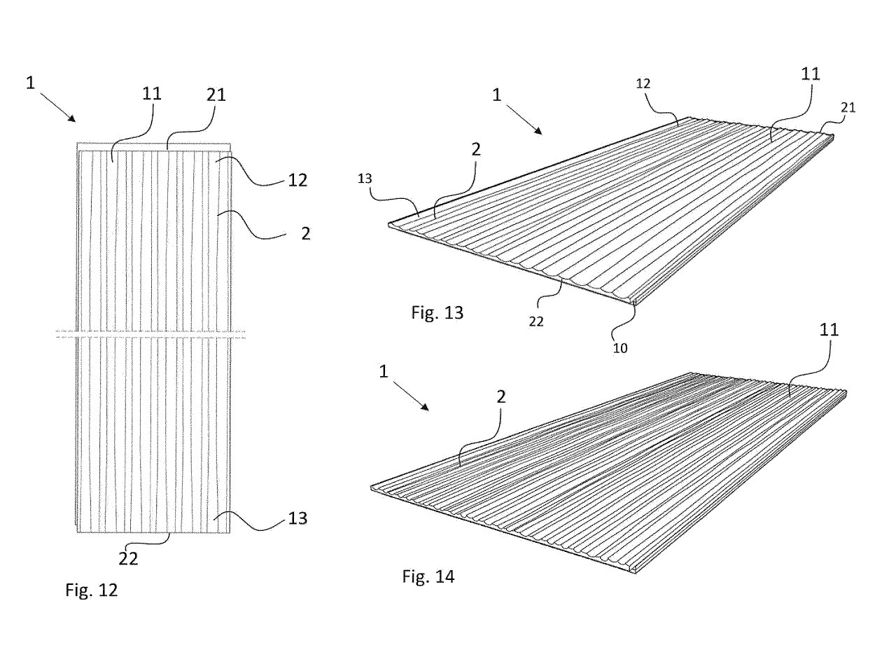

The length and the width of the façade element 1 can be chosen to fit various standards for construction, and different types of buildings. Suitable height (h in FIG. 7) can be from 0.5 to 12 m, preferably from 2 m to 12 m and a suitable width (w in FIG. 7) can be from 0.5 m to 12 m, preferably from 0.5 to 3 m. The thickness of the façade element 1 may be, for example, from 48 mm to 175 mm. The thickness is chosen depending on the use of the façade element 1. In a cold climate and/or a noisy environment and thicker façade element may be desired. Also, when the façade element 1 is used to build a façade without a framework 14 the façade element will constitute a structural part of the building and should have a thickness to support the building itself.

The façade element has an outer surface 2 and an inner surface 3. The element 1 is meant to be mounted on the façade with the outer surface 2 facing outwards and the inner surface 3 facing in towards the framework 14 of the building. The outer surface 2 may be formed by the outer layer 6.

The façade element 1 comprises cross-laminated wood which makes the panel durable and stiff. Also, as it has become increasingly expensive to obtain longer dimensions of timber, cross laminated wood makes it possible to use timber elements for construction that otherwise would be too short for use in a building.

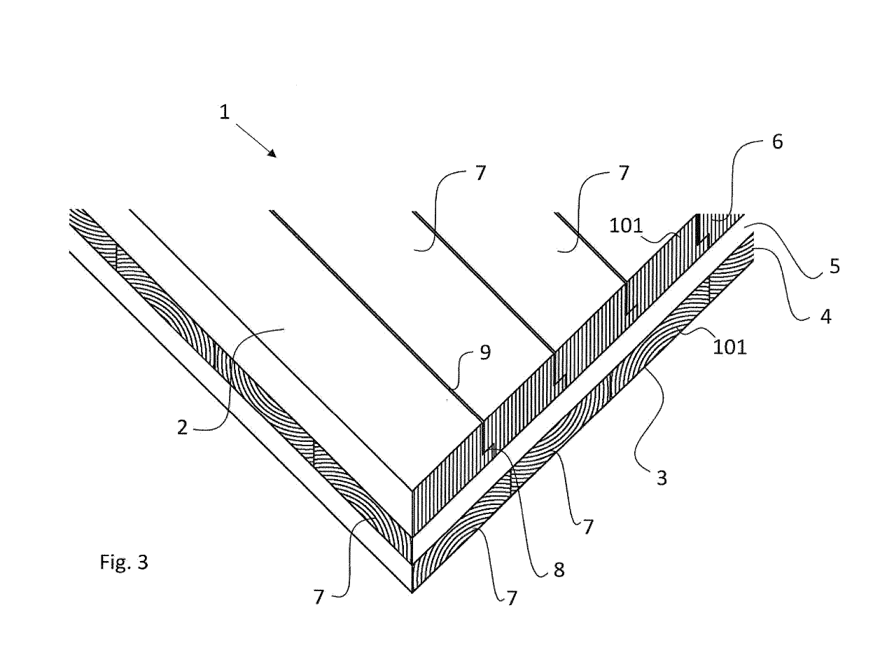

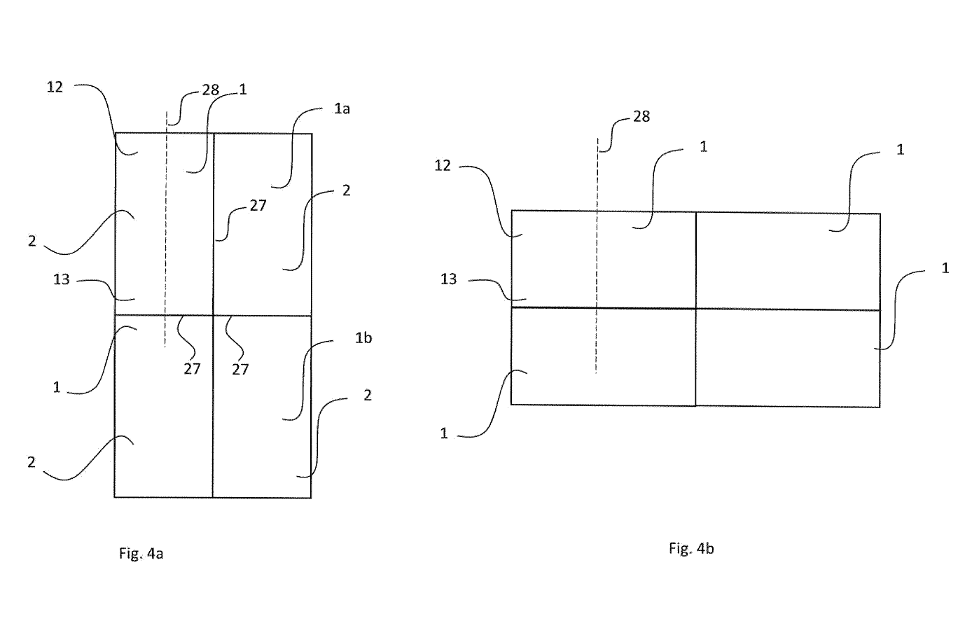

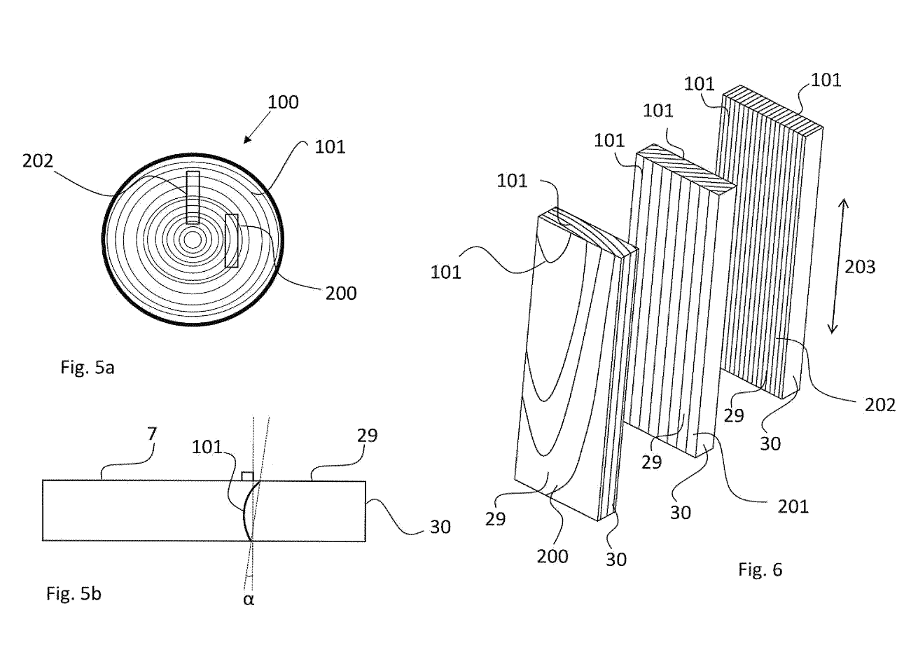

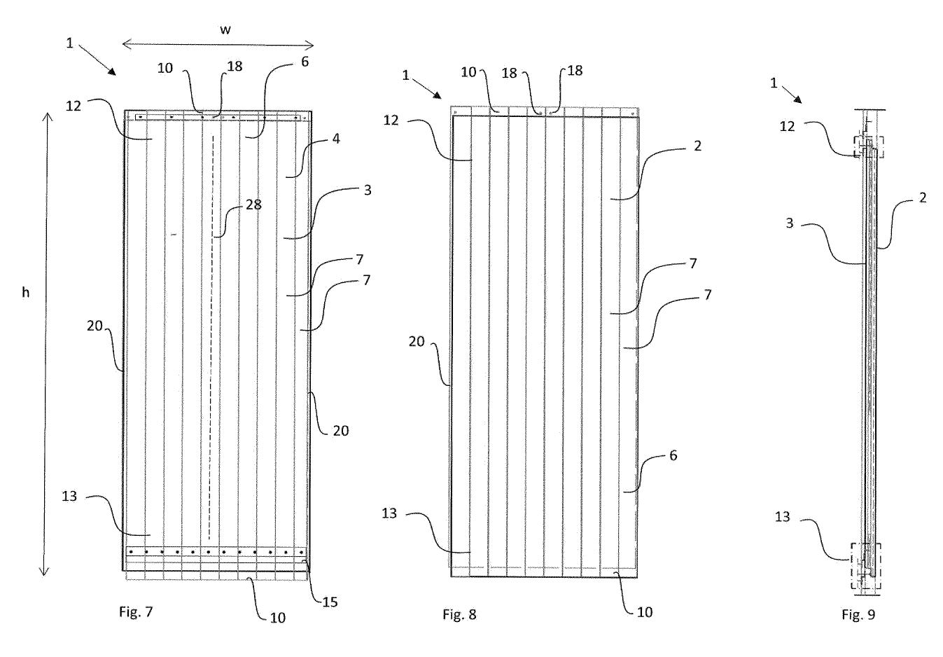

The façade element 1 comprises at least three layers of wood. With reference to FIG. 2-3, the façade element 1 comprises an inner layer 4, at least one intermediate layer 5 and an outer layer 6. The at least one intermediate layer 5 is arranged between the inner layer 4 and the outer layer 6. All three layers 4, 5, 6 are composed of timber elements 7 that are elongated pieces of wood that preferably have a rectangular cross section, so that they have a wider face 29 and a thinner face 30 (FIG. 5b). “Timber” is used in its British English meaning herein, i.e. refereeing to sawn wood products. The timber elements 7 can be made from shorter timber elements 7 that are joined one after the other in an end-to-end fashion. The wood of the timber elements 7 is preferably heartwood (while avoiding the pith), not sapwood.

The timber elements 7 may be from softwood, such as wood from a conifer such as spruce and pine. Wood from Norwegian spruce (Picea abies) or Scots pine (Pinus sylvestris) and corresponding North American species, are suitable.

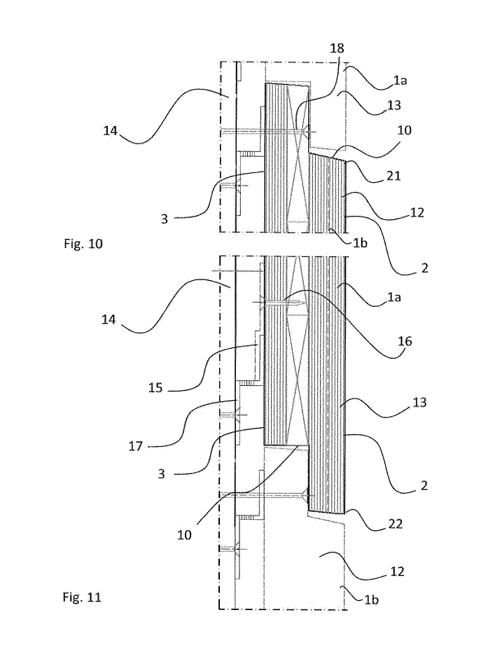

The inner layer 4, the intermediate layer 5 and the outer layer 6 may consist of or comprise timber elements 7 that are flatsawn 200 (see FIG. 6).

The outer layer 6 preferably comprises or consists of high-quality wood, such as for example wood according to standard classes G4-0, G4-1 or G4-2 according to European standard EN 1611-1:1999 or Swedish P-standard 053 (as applied to the wood types mentioned herein).

The outer layer 6 preferably comprises or consists of timber elements 7 of quartersawn timber or riftsawn timber, where quartersawn timber is preferred.

FIG. 6 shows flatsawn timber 200, riftsawn timber 201 and quartersawn timber 202. Lines 101 indicate annual rings.

“Quartersawn timber” as used herein refers to timber with annual rings 101 approximately perpendicular to the wider face 29 of the timber element 7. Quartersawn timber may also in some markets be referred to as timber with “standing annual rings” or “vertical annual rings”. “Approximately perpendicular” shall mean angles α in FIG. 5b of up to 30°, preferably up to 20°, more preferably up to 10°, even more preferably up to 5° and most preferably up to 3° between the annual ring 101 and a line that is perpendicular to the wide face 29 of the timber element 7. Annual rings 101 are slightly curved and it is referred to FIG. 5b for the measurement of angle α.

Arrow 203 indicates the grain direction of the wood in the timber elements 200, 201 and 202.

Riftsawn timber shall mean timber where the annual rings are at an angle α of from 30° to 60° to the wide face 29 of the timber element 7. However, quartersawn timber is preferred, since it has a lower cost than riftsawn timber.

FIG. 5a shows a tree trunk 100 with a multitude of annual rings 101. A quartersawn timber element 202 is shown as well as a timber element 200 that is flatsawn. The annual rings 101 of timber element 202 are approximately perpendicular to the wide face of the timber element.

Although more expensive than flatsawn timber, quartersawn timber has advantages. It is more resistant to warping than wood sawn in other ways, i.e. it does not change its shape as much as other types of timber in response to changes in moisture and/or temperature. Also cracks in the surface of the wood do not form to the same extent in quartersawn timber. Quartersawn timber is therefore often used in certain details for music instruments such as violins and guitars. Quartersawn timber is also less resistant to mildew. Therefore it does not have to be painted or oiled, but ages nicely anyway.

Quartersawn wood also provides a more uniform surface, since the annual rings 101 will be less visible than in flatsawn timber. Flatsawn timber 200 has very conspicuous annular rings 101 as can be seen in FIG. 6, which may be undesirable.

Quartersawn timber is expensive and it is therefore preferably used only where these advantages are most important, i.e. in the outer layer 6.

When the façade element 1 consists of three layers of timber elements 7 the timber elements 7 preferably have a thickness that provides durability and insulation while not being too heavy and requiring too much raw material. The thickness of the timber elements 7 of the inner layer 4 and the intermediate layer 5 is suitably, each, 16-35 mm, more preferred 16-24 mm, were 18-20 mm is even more preferred and 19 mm is the most preferred thickness. The thickness of the timber elements 7 of the outer layer 6 is suitably 20-45 mmm, more preferred from 26 mm to 32 mm when the outer layer is going to be milled (see below), otherwise the outer layer 6 can have the same thickness as the inner layer 4 and the intermediate layer 5. The façade element 1 shown in the figures consists of three layers. However, the façade element 1 may consist of four, five, six or more layers which then suitably are made thinner than indicated above.

The timber elements 7 of the inner layer 4 and the intermediate layer 5 are preferably essentially cuboid as shown in FIG. 3 as this provides for efficient stacking during production of the façade elements. The timber elements 7 of the outer layer 6 and the inner layer 4 preferably has a length that is the same as the height of the façade element 1. Thus, the timber elements 7 are preferably not joined. Similarly, the length of the timber elements 7 that make up the intermediate layer 5 preferably has a length that is the same as the width of the façade element 1.

The grain direction of the inner layer 4 and the at least one intermediate layer 5 are at least partially oriented in different directions. Preferably the angle between the grain directions is from 60° to 90°, and most preferred the angle is 90° such that the grain direction of the inner layer 4 is perpendicular to the grain direction of the at least one intermediate layer 5, as can be seen in FIG. 3.

The grain directions of the outer layer 6 and the at least one intermediate layer 5 is preferably at least partially oriented in different directions. Preferably the angle between the grain directions is from 60° to 90°, and most preferred the angle is 90° such that the grain direction of the outer layer 6 is perpendicular to the grain direction of the at least one intermediate layer 5, as can be seen in FIG. 3. Thus the grain direction of the outer layer 6 and the inner layer 4 may be the same, or almost the same.

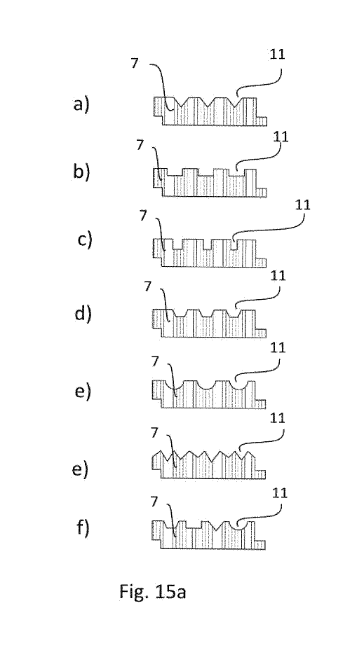

The element 1 may have an upper end 12 and a lower end 13, arranged in said mounted position facing substantially upwards and substantially downwards, respectively. The upper end 12 and lower end 13 may have different fittings such as different mounting means. Also, rabbets 10 may have different designs in the upper end 12 and lower end 13 as seen in for example FIG. 10-11. The rabbet 10 of the lower end 13 and the rabbet 10 of the upper 12 end may form a lap joint such that a part of the lower end 13 of an upper element 1a is arranged outside of a part of the upper end 12 of a lower element 1b when the elements 1a, 1b are both mounted, in a respective mounted position above one another, on the façade. This prevents water seepage.

The upper 12 and lower ends 13 define a longitudinal axis 28 of the element as shown in FIGS. 4 and 7, arranged to be substantially vertical in said mounted position. The grain direction of timber elements 7 of the outer layer 6 is preferably parallel or approximately parallel to the longitudinal axis 28. This avoids trapping of water on the surface of the façade. Approximately parallel shall include an angle between the grain direction and the longitudinal axis 28 of up to 10°, more preferred up to 8°, even more preferred up to 5°, even more preferred up to 3°.

The façade element 1 is preferably arranged for mounting in an orientation in which the longitudinal axis 28 is substantially vertical, and in which the outer surface 2 faces outwards from the façade of a building onto which the façade element is mounted. Thus, in the mounted position the grooves 11 are substantially vertically arranged.

The timber elements 7 of the outer layer 6 suitably have a respective width of 70 mm-140 mm, preferably 94 mm-120 mm. (The width being measured on the side that is on the outer surface). Smaller dimensions of timber elements 7 can be used for the inner layer and the intermediate layer.

The timber elements 7 may have a roughly rectangular or parallelogram-shaped cross section as can be seen in FIGS. 2, 3 and 5b, however that the timber elements 7 of the outer layer 6 may also comprise rabbets 8 so that adjacent timber elements 7, can be connected with lap joints 9 (FIG. 3). This decreases the risk of water seepage from the exterior into the element 1 and into the building.

Referring to FIGS. 4a, 4b, 4d, 7, and 8, the sides of the façade element 1 itself are also suitably equipped with rabbets 10, 20 or bevels 33 that reduce the risk of water seepage in joints 27 between mounted elements 1. The rabbets 10, 20 or bevels 33 are designed so that that water seepage between elements 1 is minimized.

Preferably the rabbets 10 are designed as shown in FIGS. 10 and 11 and 4d i.e. such that, when the elements are mounted one above the other on the façade, a part of the lower end 13 of an upper element 1a covers, i.e. is outside of, the upper end 12 of the lower element 1b, in order to prevent water seepage. Rabbets 10 may be slanted in a downwards-outwards direction, in order to provide the drainage of rainwater, in particular rabbets 10 at the upper end 12 as shown in FIG. 10. Preferably there are also rabbets 20 on the sides of element connecting the upper end 12 and the lower end 13, 1 as shown in FIGS. 1, 2, 7 and 8. The terms “upper” and “lower” refer to the element 1 as seen in said mounted position.

Instead of rabbets 10 the façade elements 1 may be provided with bevels 33 as shown in FIG. 4e, which serves the same purpose. Thus the bevels 33 may be such that a part of the lower end 13 of a mounted upper element 1a is outside of a part of the upper end 12 of an element 1b, mounted below the upper element 1a.

Optional end-closing piece 25 of FIG. 2 has a width which is roughly equal to the combined thickness of the inner layer 4 and the intermediate layer 5.

The façade element 1 may be provided with mounting means 32 for mounting the façade element 1 on the framework 14 of a building in a permanent manner, such as mounting brackets or prefabricated holes. In particular the inner surface 3 may be provided with mounting means 32. The mounting means 32 may comprise at least one mounting bracket 15, for example on the lower part of the inside of the façade element 1 as shown in FIGS. 10-11. The mounting bracket 15 may extend along most of the width of the façade element 1 as shown in FIG. 7. Preferably the mounting bracket 15 is made of metal material, such as steel. The mounting bracket 15 may be fastened to the inner surface 3 of the façade element 1 with fastening means such as screws or nails 16. The mounting bracket 15 is intended to be fastened to the framework 14 of the building with fastening means such as a fitting bracket 17. The mounting means 32 may also comprise premade holes for fixing the façade element 1 to a framework 14. The upper end 12 of the façade element 1 may have premade holes 18 for fastening the element 1 to the framework 14 with nails or screws, as seen in FIG. 10-11. There may be an air gap between the framework 14 and the element 1.

The outer surface 2 of the façade element 1 is preferably such that when several façade elements 1 are mounted on a façade, the outer surface forms a continuous surface as shown in FIGS. 4c and 4d. Preferably the lower edge 22 of the outer surface 2 and the upper edge 21 of the outer surface 2 a façade element 1 is located at the same distance from the framework 14 of the building as shown in FIG. 4d and FIG. 4e. This makes the horizontal gaps between two identical façade elements 1 nearly invisible, thereby obtaining a continuous surface, which is an advantage of the invention. It should be noted that the gap between the individual façade elements 1 in FIGS. 4d and 4e are exaggerated. When the outer surface 2 has grooves 11 the grooves 11 are preferably arranged to match at the upper edge 21 and the lower edge 22 as described below with reference to FIG. 15b.

The outer surface 2 may be essentially flat as shown in FIG. 3. The façade formed by the element 1 will then have an even surface.

However, in a preferred embodiment, the outer surface 2 may preferably have a pattern of grooves 11. The grooves 11 are preferably facing towards the exterior of the façade, i.e. they are externally facing grooves. The grooves 11 of the façade element 1 may be straight or curved (for example S-shaped) when the façade is observed from the outside. However, straight grooves 11 are preferred. Straight grooves lead water away better. Curved grooves may trap water, which is undesirable.

The pattern of grooves 11 may be decorative but also serves the purpose of obscuring damages resulting from wear and tear on the surface of the façade. Wood surfaces are prone to cracking with age. In addition the grooves 11 prevent the formation of cracks in the surface by releasing tensions. Any cracks that form will be smaller. Thus, the grooves 11 provide the additional advantage of releasing tensions in the surface 2. The grooves 11 also improves the acoustic properties of the façade element by deflecting or diffracting sound waves. This may dampen noise.

A wide variety of patterns can be achieved by milling or routing the outer surface 2 as described below.

The vertical grooves 11 can be designed in many different ways. The purpose of vertical grooves 11 may serve the purpose of transporting away rain water from the surface of the façade. Horizontal grooves should be avoided in climates where water seepage can be a problem, as this may trap water that causes mildew. Thus, in a preferred embodiment shown in FIGS. 1-2 and 12-15a and 15b, the outer surface 2 of the façade element 1 has a number of grooves 11 that are parallel or approximately parallel to the longitudinal axis 28, thus being vertical grooves in said mounted position of the element 1. The grooves 11 are preferably parallel or approximately parallel to each other. Approximately parallel shall include an angle between the grooves 11 and the longitudinal axis 28 of up to 10°, more preferred up to 8°, even more preferred up to 5°, even more preferred up to 3°. Thus, the grooves 11 and the wood grain will have approximately the same direction.

When the element 1 has the general shape of a rectangle when the element is mounted on a façade and seen from outside the building, it is preferred that the grain direction and the grooves 11 are parallel or approximately parallel to a side of the rectangle, where “approximately parallel” shall be understood as described above.

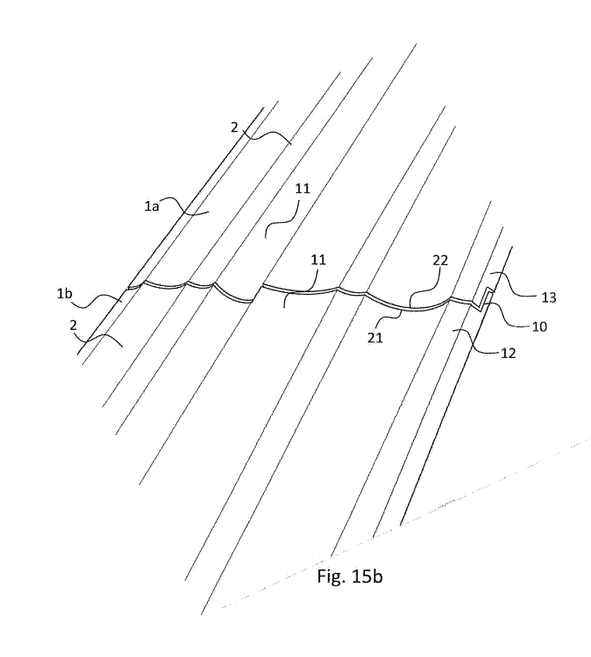

The grooves 11 can have many different profiles. FIGS. 12-15a and 15b shows examples of different profiles of grooves 11. FIG. 15a shows examples of timber elements 7 of the outer layer 6.

In particular the grooves 11 may have a profile that is U-shaped, as can be seen in FIGS. 1, 2 and 12-14. The U-shaped profile provides for a number of grooves 11 that collect and transport rain water downwards along the surface of the panel 1 in an efficient manner.

FIGS. 1, 12, 13, 14 and 16 show examples of U-shaped grooves that cover the entire outer surface 2. The grooves 11 are straight and parallel to each other and parallel to the longitudinal axis 28.

The maximum depth of the grooves 11 can be from 3 mm to 20 mm, preferably 5-15 mm deep, and most preferably 8-12 mm deep. The depth and width of the grooves 11 may vary over the outer surface 2 as shown in FIGS. 1 and 13-14, 15b, and 17-18. The width of the grooves are preferably from 1 cm to 20 cm.

However, when the outer surface 2 has a generally rectangular shape it is preferred that the thickness of the façade element 1 is the same along the various points along the upper edge 21 as along the lower edge 22 of the outer surface (FIG. 10-11), preferably such that continuous grooves are created when elements 1 are joined in the mounted position and where the grooves 11 are vertical, as shown in FIG. 15b which shows two identical façade elements 1 mounted one above the other on a façade. Thus the depth and the width of the grooves 11 are preferably the same at upper edge 21 as at lower edge 22. Thereby, when the façade elements 1 are mounted, the distance from the framework 14 to the upper edge 21 will be the same as the distance from the framework 14 to the lower edge 22 along the length of upper edge 21 and lower edge 22 of outer surface 2. In FIG. 15b the façade elements thus has a thickness at the upper edge 21 that varies along the upper edge 21 of the outer surface 22, and a thickness that varies along the lower edge 22 of outer surface 2, but the thickness at various points at the upper edge 21 and the lower edge 22 of the outer surface 2 is the same. This enable building of façades with almost invisible joints.

In a similar manner it is preferred that the thickness of the element is the same along the vertical edges. This enables the formation of a façade where the joints 27 in FIG. 4 between two neighboring façade elements 1 is less visible or invisible.

The pattern of grooves 11 is preferably such that essentially every part of the outer surface 2 of the outer layer 6 is a part of a groove 11. Examples of such patterns are shown in FIGS. 1-2, and 13-14 and FIG. 15b.). It is suitable that at least 30%, more preferably 40% more preferably at least 60%, more preferably at least 80%, more preferably at least 95%, and most preferably at least 99% of the surface area of the outer surface 2 is covered by grooves 11. The entire outer surface 2 may be covered by grooves 11, as shown in FIGS. 1, 13 and 14.

Lamination of the laminated façade element 1 can be done as is well known in the art. Standards DIN 1052 and EN 301 provides guidance in the field. Suitable pressures include pressures from 2 to 5 MPA.

Glue that can be used includes glue according to Swedish standards SS-EN 204 and SS-EN 12765, classes D4 or C4 respectively, or PUR adhesive which is completely solvent and formaldehyde free and tested in accordance with DIN 68141. A suitable glue is Casco Melamin.

Preferably the timber elements 7 are, in a first step, laminated into a block to obtain a piece of cross laminated wood which may have the shape of a rectangular prism or a rectangular parallelepiped. The cross laminated wood piece is composed as described above, however, the grain direction of the wood elements 7 of the outer layer 6 may be parallel or approximately parallel to a side of the piece of wood and simultaneously parallel to the outer surface 2, there by obtaining the direction of fibers of FIG. 3 Approximately parallel shall include an angle between the grain direction and the side of the rectangular parallelepiped of up to 10°, more preferred up to 8°, even more preferred up to 5°, even more preferred up to 3°.

In the next step, the grooves 11 and/or rabbets 10, 20, if any, are then formed. The grooves 11 and/or rabbets 10, 20 are suitably obtained by milling. Alternatively routing can be used. An advantage with using milling is that rabbets 10, 20 can also be obtained by milling in the same work step. Milling can be done to create an upper end 12 and a lower end 13 of the element 1.

It is realized that other methods for forming the grooves 11, apart from milling, may also be useful, such as for example, by forming the outer layer 6 by laminating together timber elements of different thicknesses.

When rabbets 10, 20 are formed by milling, milling may also be carried out on the inner layer 4 and the intermediate layer 5 (see for example FIG. 11).

Milling of the grooves 11 is preferably carried out such that grooves 11 are straight and approximately parallel to the grain direction of the outer layer, were approximately parallel shall have the meaning described above.

Preferably, milling of grooves 11 is carried out to a depth that does not cut through the outer layer 6 of the element, but saves a suitable thickness of material, such as at least 25%, preferably 50%, of the total thickness. Preferably, milling is not carried out deeper than 15 mm when the outer layer is 32 mm thick.

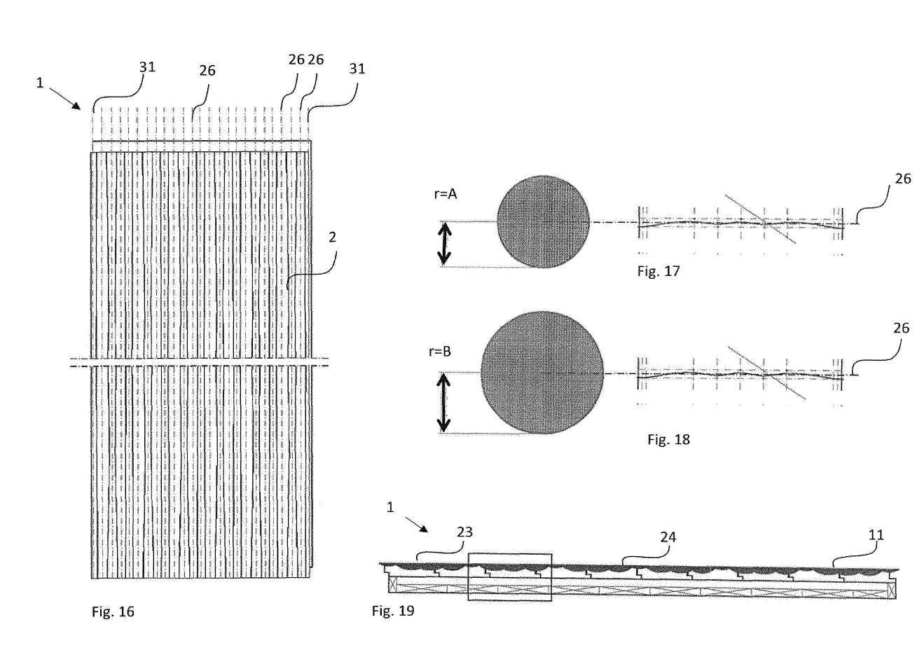

A wide variety of complex patterns, including the U-shaped grooves mentioned above, can be obtained if a computer numerical control (CNC) milling machine is used. FIGS. 16 to 19 show how a milling machine can use two different milling tools with radius (r) A and radius B to obtain a pattern of U-shaped grooves 11 on the outer surface 2 of the façade element 1. FIG. 16 shows the outer surface 2 of the façade element 1 with tool paths 26 for milling. The tool paths 26 shown in FIG. 16 create straight grooves 11. Certain tool paths 31 create rabbets 20. FIGS. 17 and 18 are diagrams that show how deep the milling tool with radius A and B respectively works from upper end to the lower end of the façade element 1. In Diagrams 17 and 18 the y-axis indicates the depth of cutting into the outer layer 6. The x-axis indicates the position along the tool path 26, 31. It can be noted that the tools start and stop at the same depth level, resulting in the aforementioned level joints 27 at the upper 21 and lower 22 edge of outer surface 2, such that continuous grooves are created when elements 1 are joined.

FIG. 19 shows the element 1 seen from a short end (upper or lower end) where 23 indicates the outer surface of the piece of wood before milling and the black marked part 24 shows what is removed by milling of grooves 11.

If a five-axis CNC milling machine is used, a number of complex patterns can be created including slalom-shaped or S-shaped grooves 11.

In general during milling procedures the part to be milled is strapped to a milling table. Nevertheless, the item may tend to move during milling, which is undesirable. The block of cross laminated wood according to the invention is surprisingly easy till mill. This is because it is so heavy as not to move easily during milling.

1. A cross-laminated wood façade element 1 that has an upper end 12 and a lower end 13, an inner surface 3, an outer surface 2 and a longitudinal axis 28 in the direction from the upper end 12 to the lower end 13, said element 1 comprising an inner layer 4 of timber elements 7 and at least one intermediate layer 5 of timber elements 7 where the grain of the timber elements 7 of the inner layer 4 and grain of the timber elements 7 of the at least one intermediate layer 5 are at least partially oriented in different directions, the façade element 1 further comprising an outer layer 6 comprising timber elements 7 in which the grain direction is oriented approximately parallel to the longitudinal axis 28, characterized in that the outer surface 2 of the façade element 1 has grooves 11 that are approximately parallel to the longitudinal axis 28.

2. The cross-laminated wood façade element according to claim 1 where the grooves 11 have been obtained by milling or routing the outer surface 2 of the façade element 1.

3. The cross-laminated wood façade element according to claim 1 or 2 where the outer layer 6 comprises quartersawn timber elements 7.

4. The cross-laminated wood façade element according to any one of the previous claims where the grooves has a profile that is U-shaped.

5. The cross-laminated wood façade element according to any one of the previous claims where the grooves 11 are straight.

6. The cross-laminated wood façade element according to any one of the previous claims where the entire outer surface 2 is covered by grooves 11.

7. The cross-laminated wood façade element according to any one of the preceding claims where the timber elements 7 of the outer layer 6 of the façade element 1 are connected with the use of rabbets 8.

8. The cross-laminated wood façade element 1 according to any one of the preceding claims which has rabbets 10 or bevels 33 such that, when two façade elements are mounted one above the other on a façade, a part of the lower end of the upper element is outside of a part of the upper end 12 of the lower element.

9. The cross-laminated wood façade element 1 where the thickness of the element 1 varies along the upper edge 21 of the outer surface 2, and where the thickness of the façade element 1 varies along the lower edge 22 of outer surface 2, and where the thickness at opposing points at the upper edge 21 and the lower edge 22 of the outer surface are the same.

10. The cross-laminated wood façade element according to any one of the preceding claims where, when the façade element is mounted on a framework, the distance from the framework 14 to the lower edge 22 of the outer surface 2 of the façade element is the same as the distance from the framework 14 to the upper edge 21 of the outer surface 2.

11. The cross-laminated wood façade element 1 according to any one of the preceding claims which has at least one mounting means 32 for mounting the façade element 1 on the framework of a building.

12. Façade of a building, comprising a plurality of façade elements 1 according to any one of the preceding claims, arranged in a row or matrix pattern next to one another.

13. A method for making a cross-laminated wood façade element comprising the steps of:
a) preparing a piece of cross-laminated wood with the general shape of a rectangular parallelepiped that comprises an inner layer 4 of timber elements 7 and at least one intermediate layer 5 of timber elements 7 where the grain of the timber elements 7 of the inner layer 4 and the grain of the timber elements 7 of the at least one intermediate layer 5 are at least partially oriented in different directions, the piece of cross laminated wood further comprising an outer layer 6 of timber elements 7 where the grain direction of the outer layer is oriented approximately parallel to the outer surface of the outer layer and parallel to a side of the rectangular parallelepiped,
b) shaping the piece of cross laminated wood by milling or routing.

14. The method according to claim 13 where milling or routing is carried out on the outer layer 6 to obtain grooves 11 that are approximately parallel to the grain direction of the outer layer.

15. The method according to claim 13 or 14 where milling or routing is used to create at least one rabbet 10, 20 for joining one façade element 1 to another façade element 1.

16. The method according to any ones of claims 13 to 15 where milling is carried out with a computer numerical control (CNC) milling machine.
